(19) United States
(12) Patent Application Publication
(10) Pub. No.: US 2026/0360857 A1
(43) Pub. Date: Nov. 12, 2026

(54) Energy Storage Apparatus for a Motor Vehicle

(71) Applicant: Bayerische Motoren Werke Aktiengesellschaft, Muenchen (DE)

(72) Inventor: Andreas RUCKER, Augsburg (DE)

(21) Appl. No.: 19/122,877

(22) PCT Filed: Nov. 29, 2023
(86) PCT No.: PCT/EP2023/083501

§ 371 Date: Apr. 21, 2025

(30) Foreign Application Priority Data
Dec. 7, 2022 (DE) 10 2022 132 438.9

(51) Int. Cl. H01M 10/6557; H01M 10/613; H01M 10/625; H01M 10/643; H01M 50/249

(52) U.S. Cl. CPC H01M 10/6557; H01M 10/613; H01M 10/625; H01M 10/643; H01M 50/249

(57) ABSTRACT

A method for manufacturing an energy storage apparatus comprising a plurality of energy storage cells accommodated in an energy storage housing device, a temperature-regulating region thus being formed between these at least two energy storage cell rows, and comprising an energy storage temperature-regulating device comprising at least one temperature-regulating channel, one such temperature-regulating channel being arranged in said temperature-regulating region, comprising the following steps: arranging the multiplicity of energy storage cells in at least two energy storage cell rows in the energy storage housing device, introducing a flexible temperature-regulating channel tube into said temperature-regulating region, introducing a temperature-regulating channel excess pressure in said temperature-regulating channel tube in order to shape the temperature-regulating channel, introducing an energy storage filling compound into the energy storage housing device and thereby at least partially or completely surrounding the temperature-regulating channel with the energy storage filling compound.

### BACKGROUND AND SUMMARY

The invention relates to a method for manufacturing an energy storage apparatus for a motor vehicle, and to an energy storage apparatus which is manufactured by this method. A battery module having condensate and propagation protection, a traction battery having a battery module of this type, and an electrified motor vehicle having a traction battery of this type are known from DE 10 2020 119 450 A1.

The invention is described hereinafter with reference to an energy storage apparatus which is configured as a traction battery for an electrified motor vehicle, wherein no limitation of the invention to an application of this type is to be inferred herefrom. In an electrified vehicle, the traction battery—subject to the provision of a corresponding electrical range—is a major cost driver, such that a cost-effective manufacture of this energy storage apparatus is advantageous. Moreover, an energy storage apparatus of this type, in comparison with other components of the electrified motor vehicle, assumes a relatively high weight.

In addition to components for storing electrical energy in a chemically bonded form, or “energy storage cells”, the energy storage apparatus comprises further components, particularly for the temperature regulation of these energy storage cells. The present invention addresses the function of temperature regulation, or the manufacture of the structure for the provision of this function. It is known for a temperature-regulating channel, i.e. a component for the conveyance of a temperature-regulating medium for the heat-up or cooling of energy storage cells, to be configured in the form of a “rigid” component in an energy storage apparatus of this type, wherein a rigid component of this type is to be understood as a metal component or a plastic component which is designed to undergo no significant change of shape, either during the manufacture of the energy storage apparatus or during the regulation operation thereof. The temperature-regulating channel can thus be configured in the form of a “cooling coil”, the shape of which is established by a shaping method, prior to the employment of the cooling coil in the energy storage apparatus. The cooling coil thus formed is then employed as a rigid component in the energy storage apparatus, which rigid components employed for temperature regulation thus assume a high weight, and it is moreover necessary for individual components, in particular components of the “energy storage module” (energy storage cells and components for the cooling thereof), to be particularly dimensionally stable, as the multiplicity of components is associated with deviations in the geometrical dimensions of extension of the energy storage module.

In this context, an object of the invention is the disclosure of a method for manufacturing an improved energy storage apparatus, which object is fulfilled by a method according to the present disclosure, and by an energy storage apparatus which is manufactured by this method according to the present disclosure. Preferred further developments of the invention are also the subject matter of the present disclosure.

The invention proposes a method for manufacturing an energy storage apparatus, wherein the energy storage apparatus comprises a multiplicity of energy storage cells. Within the meaning of the invention, an energy storage apparatus is understood as an apparatus for the take-up and output of electric power in the form of current and voltage, and for the storage of this electric power in the form of chemically bonded energy, wherein an apparatus of this type can also be understood as a “secondary battery”. Preferably, an energy storage apparatus of this type is configured as a “traction battery” for an electrified motor vehicle, which comprises an energy storage module having energy storage cells and having a temperature-regulating device for the cooling and/or heat-up of these energy storage cells, and having an energy store housing device for accommodating this energy storage module. Further preferably, these energy storage cells of the energy storage apparatus are configured as battery storage cells, in conjunction with the charging or discharging of which waste heat can be generated and, further preferably, these energy storage cells are configured as “round cells”. In particular, a round cell of this type assumes an essentially circular cross-sectional area and, with respect to the chemical structure thereof, an energy storage cell of this type can be configured as a lithium-ion storage cell. Energy storage cells, in the intended installation position of the energy storage apparatus, are preferably oriented upright, such that a cylindrical axis of an energy storage cell of this type, or of all the energy storage cells in the energy storage device, in the intended installation position, are vertically oriented. Further preferably, energy storage cells of this type can also be recumbent, and are thus oriented horizontally vis-à-vis the cylindrical axis thereof. Further preferably, the energy storage cells are arranged in multiple rows next to one another or, in particular, arranged one above another in a horizontal orientation, in an energy store housing device.

Within the meaning of the invention, an energy store housing device of this type is to be understood as a device which at least partially, and preferably entirely encloses the multiplicity of energy storage cells and which, further preferably, is designed to position the energy storage apparatus, and thus the multiplicity of energy storage cells, in particular in a motor vehicle, and to further protect the energy storage cells against external influences. Figuratively speaking, the energy store housing device can be understood as a battery housing.

As described above, the multiplicity of energy storage cells are accommodated in the energy store housing device such that energy storage cell rows are formed. Preferably, at least two energy storage cell rows are arranged adjacently to one another in the energy store housing device, such that individual energy storage cells of the two energy storage cell rows are not in mutual contact but, instead, a “temperature-regulating region” is formed between these two energy storage cell rows. Geometrically, a temperature-regulating region of this type can be understood as the interspace between two adjoining energy storage cell rows. In functional terms, a device can be arranged in this temperature-regulating region, by which heat can be extracted from energy storage cells in the two energy storage cell rows (cooling), or by which heat can also preferably be introduced into the energy storage cells (heat-up) wherein, in particular, this heat-up or cooling is executed in such a manner that these energy storage cells are operable within a stipulated temperature window. In particular, a temperature-regulating channel is geometrically arranged between two adjoining energy storage cell rows, which temperature-regulating channel is a constituent of an “energy store temperature-regulating device”. In a preferred embodiment, the energy storage module is thus structured such that, where energy storage cells are lined up in an energy storage cell row in a longitudinal direction, one energy storage cell row and a temperature-regulating channel respectively alternate in a widthwise direction of the energy storage module. In a further preferred embodiment, two energy storage cell rows are respectively arranged in direct mutual proximity in this widthwise direction, and at least one temperature-regulating channel is then arranged in direct proximity to, or in contact with at least one of these energy storage cell rows wherein, according to this embodiment, it is further preferred that an arrangement is formed in the widthwise direction in which one temperature-regulating channel is arranged, followed by two energy storage cell rows, then followed by a further temperature-regulating channel, etc.

Within the meaning of the invention, an energy store temperature-regulating device is thus understood as a device for the cooling or heat-up, or for the cooling and heat-up of energy storage cells in the energy store housing device wherein, to this end, the energy store temperature-regulating device comprises at least one temperature-regulating channel. In particular, a temperature-regulating channel of this type is thus a channel for the conveyance of a preferably fluid temperature-regulating medium, wherein this temperature-regulating medium is designed for the take-up or release of heat from/to energy storage cells in the energy storage cell row(s) which is (are) adjacent to this temperature-regulating channel. Further preferably, the energy storage apparatus is provided with a multiplicity of temperature-regulating channels wherein, preferably, one such temperature-regulating channel is preferably adjoined by two energy storage cell rows and, further preferably, this one such temperature-regulating channel engages in at least intermittent contact with the energy storage cell rows which are arranged adjacently thereto such that, in particular, good thermal conduction and a low spatial requirement are achievable.

In this context, the invention proposes a method for manufacturing an energy storage apparatus wherein, by this method, an energy storage apparatus is manufacturable having properties which are improved in relation to energy storage apparatuses which are known from the prior art and wherein, in particular, an energy storage apparatus having superior dimensional stability and effective thermal transfer vis-à-vis the energy store temperature-regulating device. In particular, for the manufacture of an improved energy storage apparatus of this type, the proposed method comprises the following steps:
Arrangement of the multiplicity of energy storage cells in at least two, but preferably in multiple energy storage cell rows, in particular in the energy store housing device wherein, in an energy storage cell row of this type, multiple energy storage cells are arranged consecutively in a longitudinal direction. Thus, preferably, in an energy storage cell row of this type, at least two, but preferably multiple energy storage cells are arranged consecutively in this longitudinal direction. Further preferably, the energy storage cell rows are arranged with a mutual spacing in a widthwise direction. Particularly to the effect that, in each case, two energy storage cell rows are arranged with a mutual spacing, and are thus separated by the temperature-regulating region, the energy storage cell rows can be accurately arranged in the energy store housing device. In comparison with a device having a temperature-regulating channel tube which is configured as a rigid component, of the type which is known from the prior art, and in which the temperature-regulating channel tube engages in direct contact with the two energy storage cell rows, in particular for the purposes of thermal transfer, inevitable manufacturing errors cumulatively form an overall geometrical deviation, particularly in this widthwise direction. Conversely, in the type of manufacture proposed, energy storage cell rows are firstly positioned independently of a temperature-regulating channel, and thus accurately, in particular in an energy storage cell housing.

Moreover, according to the manufacturing method proposed, a temperature-regulating channel hose is arranged in the region between the two adjoining energy storage cell rows, and thus in the temperature-regulating region. The flexibility of the temperature-regulating channel hose is selected such that the latter, upon the introduction thereof into the temperature-regulating region, does not assume its final form, and is thus in an “unexpanded” state, and only assumes its final form, or an “expanded” state, in a subsequent production step. Preferably, in multiple temperature-regulating regions of the energy storage apparatus, and preferably in all the temperature-regulating regions, one such temperature-regulating channel hose is arranged in each case and, moreover, a single such temperature-regulating channel hose can also be routed through multiple, or all such temperature-regulating regions. Preferably, the temperature-regulating channel hose is at least essentially formed of an expandable plastic material. In particular, by the introduction of the flexible temperature-regulating channel hose, the accurate positioning of the energy storage cell rows is maintained.

Further to the introduction of this at least one temperature-regulating channel hose, an overpressure is applied thereto, or a “temperature-regulating channel overpressure”, wherein the term “overpressure” describes a pressure ratio between an internal volume of the temperature-regulating channel hose and the immediately surrounding environment thereof or, expressed in simple terms, a pressure ratio between the interior and exterior of the temperature-regulating channel hose. Moreover, this temperature-regulating channel hose is selected such that the above-mentioned pressure ratio results in a shaping of the pressure-regulating channel hose, and thus in a volumetric expansion of the temperature-regulating channel hose and, preferably, the temperature-regulating channel hose is at least shaped to the extent that, or the volume thereof is expanded to the extent that the two adjoining energy storage cell rows, at least partially, or preferably entirely, engage in mutual contact such that the temperature-regulating region, at least essentially, is fully occupied. Preferably, the temperature-regulating channel hose expands its volume in response to the action of the temperature-regulating channel overpressure by more than 5%, preferably by more than 15% and preferably by more than 30% and, further preferably, the temperature-regulating channel overpressure is lower than 50 bar, preferably lower than 10 bar, and further preferably lower than 5 bar. In particular, as a result of the elasticity of the temperature-regulating channel hose, the latter can engage, preferably entirely but at least partially, with the energy storage cell rows, such that a particularly large contact surface is formed between the critical surface of the temperature-regulating device and the energy storage cells of the energy storage cell rows.

It is further proposed that, further to the introduction of the temperature-regulating channel hose, and preferably also further to the application of the temperature-regulating channel overpressure, an energy store filling compound is introduced into the energy store housing device, wherein the energy store filling compound thus at least partially or entirely surrounds the temperature-regulating channel, such that the temperature-regulating channel is at least partially or entirely embedded in the energy store filling compound. Further preferably, the energy store filling compound is introduced into the energy store housing device in a liquid form. Further preferably, the energy store filling compound is converted into a foam-like consistency, or is preferably introduced into the energy store housing device in the form of a foam. Further preferably, at least partially, the energy store filling compound forms a materially bonded connection with the temperature-regulating channel hose, particularly in the expanded state thereof and, particularly preferably, the energy store filling compound maintains the at least one temperature-regulating channel hose, further to the fastening thereof, in the shape which the temperature-regulating channel hose has assumed in its expanded state.

In a preferred embodiment, the at least one temperature-regulating channel hose leads out of the temperature-regulating region, and the temperature-regulating channel hose is thus preferably routed to a “catchment region”. In particular, in this region, which preferably still lies within the energy store housing device, the temperature-regulating channel hose only adjoins at least one energy storage cell row on one side, or not at all. Further preferably, in this region, multiple temperature-regulating channel hoses are fluidically interconnected by a rigid component, or “manifold pipe”, and further preferably by at least one temperature-regulating channel manifold hose, which is flexibly embodied in the manner of a temperature-regulating channel hose of this type. Preferably, the catchment region extends at least essentially in the widthwise direction of the energy storage module. In particular, by such a configuration of the invention, it is also enabled for the connection of the temperature-regulating device to be formed by a flexible, and thus a simply manufacturable temperature-regulating channel hose, or by a rigid plastic component.

In a preferred embodiment, the temperature-regulating channel hose, at least in the temperature-regulating region, upon the application of the temperature-regulating channel overpressure, is expanded by more than 5% in relation to a state in which this temperature-regulating channel overpressure is not applied. This expansion preferably relates to the volume which is assumed by the temperature-regulating channel hose in the unexpanded state (unexpanded: no temperature-regulating channel overpressure applied/expanded: temperature-regulating channel overpressure applied). In particular, by such an expansion, a particularly simple introduction, into the temperature-regulating region, of the temperature-regulating channel in the unexpanded state is enabled, as the latter occupies a significantly smaller space than in the expanded state thereof wherein, moreover, a “large” expansion enables the achievement of effective contact between energy storage cells in the energy storage cell rows and the energy store temperature-regulating device.

In a preferred embodiment of the invention, the energy store filling compound and the temperature-regulating channel hose are mutually tailored, such that the energy store filling compound forms a materially bonded connection with the temperature-regulating channel hose, at least in the temperature-regulating region and at least partially, particularly in the event that the energy store filling compound has partially or entirely set. Further preferably, further to the introduction thereof, the energy store filling compound is cured, particularly in the event that the latter has at least partially enclosed the temperature-regulating channel hose. In particular, by the materially bonded connection of the energy store filling compound with the temperature-regulating channel hose, and the curing thereof, the temperature-regulating channel hose is at least substantially maintained in its expanded form by the energy store filling compound in a permanent manner, such that the temperature-regulating channel can thus be introduced into the temperature-regulating region in an accurately fitted arrangement.

In a preferred embodiment of the invention, the temperature-regulating channel hose, particularly further to the application of the temperature-regulating channel overpressure, engages in contact with at least one energy storage cell, preferably with multiple energy storage cells, or preferably with all the energy storage cells in an energy storage cell row, which contact, further preferably, is a full-surface contact. Figuratively speaking, particularly under the influence of the temperature-regulating channel overpressure, the elastic temperature-regulating channel clings to the energy storage cells which are grouped in energy storage cell rows, and thus engages in full-surface contact therewith. In particular, by such full-surface contact, a large contact surface is achievable, particularly in association with cylindrical energy storage cells, such that an effective thermal transfer to the temperature-regulating device is enabled.

The invention further proposes an energy storage device for a motor vehicle, and preferably a motor vehicle energy storage apparatus, preferably a motor vehicle traction battery, wherein this energy storage apparatus is manufactured by a method according to the above-mentioned claims.

The invention is described in greater detail hereinafter with reference to the at least partially schematic figures, which figures represent individual features and combinations of features, whereby it is observed that the invention can also be embodied by combinations of features other than those represented.

### BRIEF DESCRIPTION OF THE DRAWINGS

FIG. 1 shows a schematic sectional representation of three energy storage cell rows, with two unexpanded temperature-regulating channel hoses, in an overhead view;

FIG. 2 shows a schematic sectional representation of three energy storage cell rows, with two expanded temperature-regulating channel hoses, in an overhead view; and

FIG. 3 shows a schematic sequence plan for the proposed manufacturing method.

### DETAILED DESCRIPTION OF THE DRAWINGS

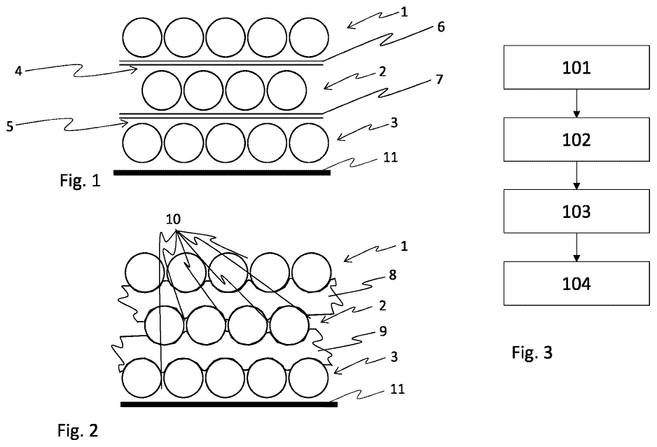

FIG. 1 shows an overhead view of a sectional representation of part of an energy storage apparatus, in particular of an energy storage module, wherein a first 1, a second 2, and a third 3 energy storage cell row can be seen. These energy storage cell rows 1, 2, 3 are formed by the consecutive arrangement of cylindrical energy storage cells in the energy store housing device 11. Exemplarily, only one sidewall of the energy store housing device 11 is represented. Between the three energy storage cell rows 1, 2, 3, the first 4 and the second 5 temperature-regulating region are formed. In these two temperature-regulating regions 4, 5, the first 6 or the second 7 temperature-regulating channel, in the production step represented, are introduced in an as yet unexpanded state.

In FIG. 2, the energy storage apparatus represented according to FIG. 1 is shown in the same view, subsequently to a further production step. In this further production step, the first 8 and the second 9 temperature-regulating channel are represented in the expanded state. The transition of the temperature-regulating channels from the unexpanded 6, 7 to the expanded 8, 9 state is achieved by the application of the temperature-regulating channel overpressure. Upon the application of the temperature-regulating channel overpressure, an overpressure prevails in the interior of the respective temperature-regulating channel hose, in relation to the immediately surrounding environment of the temperature-regulating channel hose. On the grounds of the flexible material of these temperature-regulating channel hoses, the latter expand in response to the action of the temperature-regulating channel overpressure, and thus cling to the energy storage cell rows 1, 2, 3 such that, in each case, a large contact surface between the energy storage cell rows 1, 2, 3 and the temperature-regulating channels 8, 9 is achieved. Vacant regions 10 in the energy store housing device 11 are those regions which are filled with the energy store filling compound in a further production step.

FIG. 3 represents a simplified sequence plan of the method according to the present disclosure for manufacturing an energy storage apparatus.

The first process step 101 comprises the arrangement of the multiplicity of energy storage cells in at least two energy storage cell rows 1, 2 in the energy store housing device 11. The second process step 102 comprises the introduction of the flexible temperature-regulating channel house into the at least one temperature-regulating region 4 between the at least two energy storage cell rows. The third process step 103 comprises the introduction of the temperature-regulating channel overpressure into the at least one temperature-regulating channel hose, such that the latter executes the transition from its unexpanded state 6 to its expanded state 8, such that the at least one temperature-regulating channel is shaped by this temperature-regulating channel hose.

The fourth process step 104 comprises the introduction of an energy store filling component into regions 10 of the energy store housing device 11 which are vacant, wherein such regions 11 can be unfilled, partially filled or entirely filled with the energy store filling compound.

In other words, it is known from the prior art for the cooling of cylindrical cells in a high-voltage store to be enabled by “intercell cooling”, which is executed by a cooling hose formed of aluminum, or “aluminum cooling hose”, which is arranged between the energy storage cells, and additionally by a lateral fluid conveyance, which lateral fluid conveyance is to be understood in the sense of a catchment region or manifold. It is further known for the aluminum cooling hose or aluminum cooling hoses to be electrically insulated by a plastic coating vis-à-vis the energy storage cells. The cylindrical cells, which are arranged in rows, are adhesively bonded at their shell surface to at least one adjacently arranged aluminum cooling hose, or are materially bonded thereto. The individual aluminum cooling hoses, which are arranged in the interspaces between the energy storage cells and are bonded thereto, at the axial ends thereof, and thus via mutual interfaces, are interconnected with a fluid conveyance arrangement (outflow and return flow) which represents the above-mentioned catchment region. Thereafter, a module which is provided with a cooling arrangement of this type (aluminum cooling hoses, energy storage cells), in further process steps, can be structurally potted and foam-filled with a foam material, or with another appropriate filling compound. As a result of the material bonding of a multiplicity of rigid bodies (aluminum cooling hoses, energy storage cells), inevitable manufacturing errors in the latter can cumulatively form a relatively large overall deviation.

Conversely, the present disclosure proposes a manufacturing method which provides for the employment of a flexible cooling hose, which is not comprised of a rigid material such as aluminum, such that fluid conveyance is enabled by a flexible plastic hose or hollow body, or a “temperature-regulating channel hose”. This at least one temperature-regulating channel hose is flexibly configured, and thus assumes no structural function, such as the positioning of energy storage cells or the achievement of a specific minimum clearance between two adjoining energy storage cell rows, wherein this temperature-regulating channel hose assumes only a sealing function for the conveyance of media, and thus for the conveyance of a temperature-regulating or cooling medium in the scheduled operation of the energy storage apparatus. To this end, it is proposed that the energy storage cells which, in particular, are configured as cylindrical bodies, are firstly arranged in energy storage cell rows and, thereafter, the flexible temperature-regulating channel hose which, at this time, still assumes an unexpanded state, is then positioned between two adjoining energy storage cell rows, which operation is repeated until such time as a temperature-regulating channel hose of this type is provided in all such regions in which the provision thereof is intended. The at least one temperature-regulating channel hose thus positioned is filled with a medium and, in response to the action of the temperature-regulating channel overpressure thus generated, the temperature-regulating channel hose expands, and thus clings to the shell surfaces of the energy storage cells.

In this expanded state of the at least one temperature-regulating channel hose, potting of the energy module with the energy store filling compound is then executed. By this potting, preferably all the remaining interspaces are filled. The energy store filling compound is provided such that an adhesive bond with the at least one temperature-regulating channel hose is formed. Thus, further to curing, the temperature-regulating channel remains open for the conveyance of fluid, even in the event of a drop in the filling pressure or temperature-regulating channel overpressure. A potential connection of individual temperature-regulating channels, or “lateral fluid conveyance”, can also be executed by a plastic part, which can be potted in combination therewith. Thus, in a preferred embodiment, the complete fluid conveyance arrangement can be embodied in the form of at least one thin-walled, lightweight and low-cost plastic component. The stability of the temperature-regulating channel is at least essentially provided by the energy store filling compound.

### LIST OF REFERENCE NUMBERS

1, 2, 3 First, second, third energy storage cell row
4,5 First, second temperature-regulating region
6,7 First, second temperature-regulating channel hose in unexpanded state
8,9 First, second temperature-regulating channel hose in expanded state
10 Regions to be filled with energy store filling compound
101 First step
102 Second step
103 Third step
104 Fourth step

1-6. (canceled)

7. A method of manufacturing an energy storage apparatus having a plurality of energy storage cells accommodated in an energy store housing device, wherein a temperature-regulating region is formed between at least two energy storage cell rows, and having an energy store temperature-regulating device comprising at least one temperature-regulating channel hose arranged in the temperature-regulating region, the method comprising:
arranging the plurality of energy storage cells in at least two energy storage cell rows in the energy store housing device;
introducing a flexible temperature-regulating channel hose into the temperature-regulating region;
introducing a temperature-regulating channel overpressure into the temperature-regulating channel hose, in order to shape the temperature-regulating channel hose; and
introducing an energy store filling compound into the energy store housing device, and thereby at least partially embedding the temperature-regulating channel hose in the energy store filling compound.

8. The method of manufacturing the energy storage apparatus according to claim 7,
wherein the temperature-regulating channel hose leads out of the temperature-regulating region into a region that lies within the energy storage apparatus, and in which the temperature-regulating channel hose adjoins the energy storage apparatus on only one side or not at all.

9. The method of manufacturing the energy storage apparatus according to claim 7, comprising:
expanding the temperature-regulating channel hose, at least in the temperature-regulating region, upon the application of the temperature-regulating channel overpressure, by more than 1% in relation to a state in which the temperature-regulating channel overpressure is not applied.

10. The method of manufacturing the energy storage apparatus according to claim 7, comprising:
forming a materially bonded connection of the energy store filling compounds with the temperature-regulating channel hose at least in the temperature-regulating region and at least partially.

11. The method of manufacturing the energy storage apparatus according to claim 7,
wherein the temperature-regulating channel hose, after the application of the temperature-regulating channel overpressure, engages in full-surface contact with at least one energy storage cell.

12. An energy storage apparatus for a motor vehicle, wherein the energy storage apparatus is manufactured according to the method according to claim 7.
